(19) United States
(12) Patent Application Publication
(10) Pub. No.: US 2020/0314193 A1
(43) Pub. Date: Oct. 1, 2020

(54) ACTION IN RESPONSE TO USER DEVICE SIGNATURE

(71) Applicant: Lenovo (Singapore) Pte. Ltd., Singapore (SG)

(72) Inventors: Russell Speight VanBlon, Raleigh, NC (US); Nathan J. Peterson, Oxford, NC (US); Mark Patrick Delaney, Raleigh, NC (US); John Carl Mese, Cary, NC (US); Arnold S. Weksler, Raleigh, NC (US)

(21) Appl. No.: 16/368,410

(22) Filed: Mar. 28, 2019

(51) Int. Cl. H04L 29/08

(52) U.S. Cl. CPC H04L 67/24; H04L 67/303

(57) ABSTRACT

One embodiment provides a method, including: detecting, at an information handling device, at least one user device signature in an area; determining, using a processor, an action to be performed based on the at least one user device signature; and performing, based on the determining, the action. Other aspects are described and claimed.

### BACKGROUND

Many devices (e.g., home automation devices, wireless networks, information handling devices, digital assistants, etc.) are capable of detecting the presence of various other information handling devices (“devices”), for example, smart phones, tablets, laptop and personal computers, other electronic devices, and the like. For example, a smart phone is capable of detecting the presence of another device via detecting of a signal output by the other device, for example, a user device signature. As another example, when a user having a tablet enters a home a wireless network or home automation device of the home can detect the presence of the user through detection of a signal output by the tablet.

### BRIEF SUMMARY

In summary, one aspect provides a method, comprising: detecting, at an information handling device, at least one user device signature in an area; determining, using a processor, an action to be performed based on the at least one user device signature; and performing, based on the determining, the action.

Another aspect provides an information handling device, comprising: a processor; a memory device that stores instructions executable by the processor to: detect, at an information handling device, at least one user device signature in an area; determine, using a processor, an action to be performed based on the at least one user device signature; and perform, based on the determining, the action.

A further aspect provides a product, comprising: a storage device that stores code, the code being executable by a processor and comprising: code that detects, at an information handling device, at least one user device signature in an area; code that determines, using a processor, an action to be performed based on the at least one user device signature; and code that performs, based on the determining, the action.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of detecting a user device signature in an area and performing an action in response to the detection of the user device signature.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Upon detection of the user device signature, the detecting device may perform an action, for example, requesting information regarding the user associated with the device, taking a programmed action upon detection of the signature, or the like. However, often times, users and/or the detected signature are not known to the detecting device. Therefore, the detecting device cannot take any automatic action in response to the detection of the device signature. For example, a home owner may invite multiple individual users to his/her home for an event (e.g., birthday, party, house warming, get-together, book club, holiday, vacation, etc.). With an increase in the number of people within a facility (e.g., home, business, corporation, etc.), there may be an increased need for resources, for example, food, network bandwidth, hot water, heat/air conditioning, or the like. Additionally, or alternatively, depending on the people within the facility, there may be a need for a particular resource, for example, vegetarian food options for a vegetarian, a particular room temperature for a particular person, a particular room setting (e.g., blinds drawn during the day, alarm settings, etc.), a particular laundry detergent, or the like.

Traditional techniques for accommodating guests require a user to manually prepare for the guests. In other words, traditional techniques require a home owner, or other facility manager, to know the number of people coming, remember the needs of each person coming (which may be unknown), and then prepare (e.g., buy food, change facility settings, ensure favorite items are available, etc.) for the arrival of the people. While traditional techniques do exist for determining the amount of people present in a location, for example, via detecting a number of wireless signatures present, accessing secondary sources for information regarding people present in a location, of the like, these techniques do not take actions to prepare for the people. Some home automation devices will take actions when a known person enters a dwelling. For example, when a home owner arrives home, a home automation system may be programmed to change the dwelling temperature settings. However, these techniques require knowledge of the person so that user settings that were previously stored by the person can be accessed and applied. In other words, conventional techniques do not exist that allow a detecting device to detect user device signatures associated with either known or unknown people, particularly guests within a facility, and prepare the facility for the presence of those people.

Accordingly, an embodiment provides a method for detecting a user device signature in an area and performing an action in response to the detection of the user device signature. An embodiment may detect the user device signature associated with an information handling device, for example, one carried by a user. For example, as a guest enters a home, an embodiment may detect a user device signature (e.g., wireless signal emitted by the device, device identification information, radio frequency signal, near field communication signal, etc.) of one or more devices of the guest. The term guest will be used herein throughout. However, this term is intended to broadly cover the concept of a person or user who has a device that is not associated with the facility. In other words, the term guest indicates a person who is not set within the user settings of the detecting device. Accordingly, the guest could be a previously unknown person, a person who frequents the facility but who is not programmed within or associated with the system, a previously encountered person not programmed within or associated with the system, or the like.

An embodiment may then determine if, in response to detecting the guest or user device signature, whether an action should be performed. For example, an embodiment may determine whether the user requires any specific accommodations or has a previously associated action based upon the presence of the person. For example, an embodiment may determine that last time the particular user device signature was detected, a problem occurred, so an action should be taken to prevent a reoccurrence of the problem. If an embodiment determines that an action should be taken based upon the presence of the guest, then an embodiment may perform an action (e.g., resource characteristic adjustment, ordering of supplies, etc.). For example, an embodiment may automatically order a favorite food of the guest, automatically adjust the water heater temperature, automatically adjust room characteristic scheduling, or the like. Thus, such a system and method may negate the need for a facility manager to remember guest preferences, to manually adjust resources, or the like.

The illustrated example embodiments will be best understood by reference to the figures. The following description is intended only by way of example, and simply illustrates certain example embodiments.

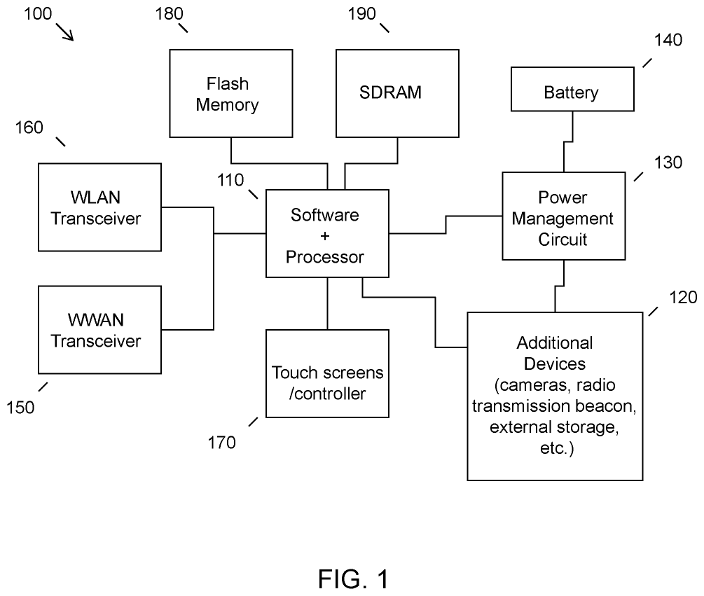

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, motion sensor such as an accelerometer or gyroscope, a thermal sensor, etc. System 100 often includes one or more touch screens 170 for data input and display/rendering. System 100 also typically includes various memory devices, for example flash memory 180 and SDRAM 190.

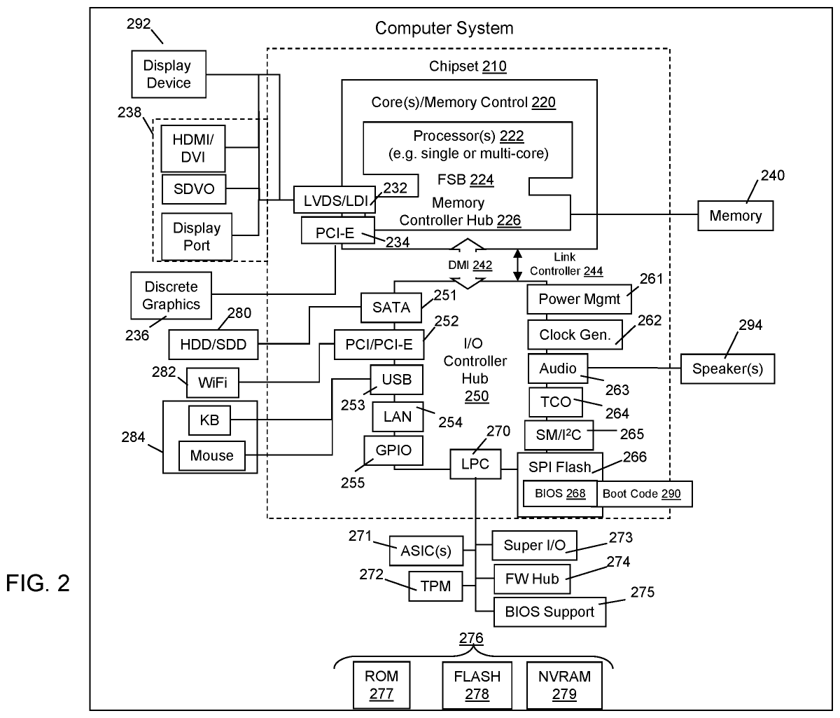

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops, televisions, personal computer devices generally, and/or electronic devices that comprise can detect user device signatures or provide user device signatures. For example, the circuitry outlined in FIG. 1 may be implemented in a tablet or smart phone embodiment, whereas the circuitry outlined in FIG. 2 may be implemented in a laptop.

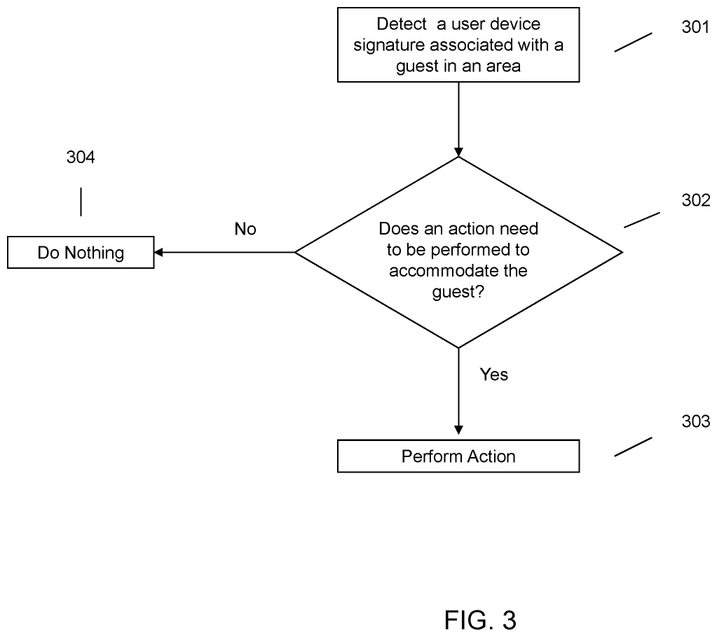

Referring now to FIG. 3, an embodiment may detect a user device signature in an area and perform an action in response to the detection of the user device signature. At 301, an embodiment may detect at least one user device signature in an area. For example, a guest may enter a facility (e.g., home, business, corporation, etc.) and a detecting device can detect a user device signature from a user device accompanying that user within the facility. As stated above, the guest may be a person or user who is “unknown” to a detecting device within the facility. In other words, the guest may be a person who does not have a user profile, user credentials, or user preferences stored on or accessible to the detecting device, because the guest is a person who does not correspond to the detecting device. For example, the guest may be a person who frequents the facility, so the detecting device recognizes the user device signature, but who is not the owner or manager of the facility or a person who corresponds to the facility (e.g., a family member of the owner, etc.), therefore, the guest is a person who does not program the detecting device with user preferences. As another example, the guest may be a person or user who has been previously detected by the detecting device, but who is not the owner or a member associated with or corresponding to the detecting device. As a final example, the guest may be a person who is has never previously been detected by the detecting device.

Detecting the user device signature may include using a detecting device within the facility to detect signals provided by a device of the guest. These signals may be used to create a user device signature and may be used to associate the user device signature with a person. Associating the user device signature with a person does not necessarily mean that the person is specifically identified, although the person can be specifically identified, but rather that a particular user device indicates that certain results should occur, as discussed in more detail herein. The detecting device may be any information handling device that can detect signals provided by other information handling devices. For example, the detecting device may be a network, home automation device, digital assistant, smart phone, or the like. The detecting device may also be a device within a group of interconnected devices, for example, an IOT (Internet-of-Things) device, a home automation device that is connected to other devices within the home, a digital assistant connected to other devices, or the like. Detection of the user device signature may be accomplished using near-field communication, wireless signals, radio frequency identification (RFID), short-range communication, or the like. The user device signature may include device identifiers (e.g., device name, device address, network identifiers, etc.), user credentials, a specific signal or signal pattern, any unique identifier associated with the device or user, or the like.

When a guest enters an area, an embodiment may utilize a detecting device to request user device signature information for any device present within the area. For example, a user may utilize a Wi-Fi network present in a house to act as the detecting device. Alternatively, the user device may broadcast the user device signature which can be received by the detecting device. In an embodiment, a central device (e.g., a Wi-Fi router, a smart phone used as a hotspot) may be utilized as the detecting device. In an embodiment, the distance of detection may be variable. For example, the distance may be a default value, selected by the user, a predetermined distance from the detecting device, based upon the strength of the user device signature, or the like. For example, the detecting device, for example, a router may detect devices within a distance that the wireless signal strength is above a predetermined threshold. As another example, a user may open a hotspot on his/her smart phone and may set the parameters for detection to a predetermined distance radius.

Although not required, an embodiment may utilize user device signatures to determine the identity of the guest. For example, the detecting device may query the device to provide additional details associated with the user (e.g., user credentials, name, identification, information associated with the device (e.g., phone number, home network name, etc.), etc.). For example, the name on the account in which a device may be connected to (e.g., smartphone service account) may be automatically assigned to a device and may thereafter be provided in identifying the user of the device. As another example, a user may provide a username during device set up that may be used to identify a user. These details may be provided through permission of the user device owner or holder. For example, user identification data may be provided by a user at the time of device set up, and the user may set the settings so that the device may publically provide identification information to nearby users or devices.

At 302, an embodiment may determine if an action should be performed in response to detecting the user device signature. The action may be an action to accommodate the guest. In an embodiment, an action may be associated with or attached to a user device signature. The action associated with the user device signature, and, thus, the guest themselves, may describe an accommodation specific to that guest. For example, a system may recognize a user device signature that indicates the user of the device prefers a higher moisture content in the air. In other words, the user of the device may specifically program his/her device with user preferences that can then be read by the detecting device. These user preferences may indicate an action should be taken in response to detection of the user device signature. Associations may be added and subtracted from a user a device signature in a system by a user, for example, either in the detecting device system or the detected device system. The action may also be based upon the identity of the user associated with the user device signature. For example, a user identified as “Mom” may result in a specific action to accommodate “Mom”.

Determining whether an action should be taken may be based upon historical information. For example, if the last time that the user device signature was detected within the area, a problem occurred or an effect was caused, the problem or effect may be stored within the detecting device system. As an example, if the last time the guest arrived at the facility (i.e., the user device signature of the guest was detected), the network bandwidth was strained, this problem may be stored in a data store for future reference. As another example, if the last time that the guest arrived at the facility, the home owner or facility manager ordered a specific food to accommodate the guest, this food preference may be stored in a data store for future reference. As a final example, if the last time that the guest arrived at the facility, the guest had a specific room characteristic preference (e.g., blinds drawn during the day, a different room temperature, fans running at night, etc.), these guest preferences may be stored in a data store for later access. Thus, an embodiment may determine an action to respond to the effect and may, thereafter, store the action in association with the user device signature.

The associations and correlations may occur automatically, meaning a user does not have to program the associations. For example, an embodiment may identify that the last time the guest arrived, the facility manager adjusted a resource characteristic (e.g., ordered a specific food, upgraded a television package, changed the temperature in a room, increased bandwidth, etc.), and an embodiment may, thereafter, establish an association with the adjusted resource characteristic and the user device signature. In other words, a guest may arrive in an area where an accommodation is necessary; as an action is being performed, for example, by the facility manager, an embodiment may recognize that the action is being performed to accommodate the guest. Thereafter, an embodiment may generate and store an association between the action that was performed and the guest's user device signature. Thus, the next time the guest arrives in the area, an embodiment may automatically access the association. Accordingly, determining whether an action should be taken may include accessing a data store (e.g., database, local data storage, remote data storage, cloud data storage, network data storage, etc.) that includes a list of correlations between the user device signature or the guest and actions taken in response to detection of the user device signature or guest.

In an embodiment, user preferences provided by the detected device or previously stored correlations or associations may be unavailable. For example, it may be first time that the user device signature has been detected within the area, the guest may not have previously stayed long enough in the area to generate an action, or the like. Additionally, the facility manager may not know that a particular guest needs a particular accommodation or that a resource will be strained or depleted until the problem occurs. In other words, the facility manager may not know that an action should be taken until it is too late. In one embodiment, the system may not recognize that an action should be taken until receipt of user input by the facility manager or the guest themselves.

Alternatively, an embodiment may determine that a problem may occur based upon knowledge of other connected devices. For example, if the detecting device is connected to a home network and the network is secured, an embodiment may identify that the guest will be unable to access the network. As another example, if the detecting device is connected to the home water system and/or mechanical system, an embodiment may determine that the current volume of hot water will run out with the addition of the guest or that the room temperature will increase due to the presence of the guest. Accordingly, an embodiment may determine that an action may need to be taken in order to proactively address these potential issues.

In one embodiment, an action may take place when the amount of user device signatures in an area surpasses a threshold value. In other words, adjustments to resource characteristics may depend on the amount guests in an area. For example, a user or the detecting device system may have previously identified that a room gets too warm when more than five people are inside the room, which may cause the user or detecting device system to set a threshold value of five user device signatures in an area. If a sixth user device signature is detected in the room, an embodiment may determine that the air conditioning should be activated, thereby, automatically decreasing the room temperature to ensure that the room does not get too warm. In an embodiment, the action taken in response to surpassing a threshold value may also be customizable by a user. Then, if the sixth person leaves the room an embodiment may revert back to the area's original settings.

Responsive to determining, at 302, that an action does not need to be performed to accommodate a guest, an embodiment may, at 304, do nothing. Alternatively, an embodiment may monitor the system and or facility manager to determine if an action should be associated with the guest for subsequent visits by the guest.

If, however, an embodiment determines at 302 that an action should be taken, an embodiment may, at 303, perform an action. This action may include the action that is stored within the data store. In other words, in an embodiment, an association between a detected user device signature and an accommodation may be recognized and an embodiment may perform that action. For example, if the user device signature is associated with a preferred air moisture content, an embodiment may automatically activate a humidifier when the user device signature is detected within an area. The user device signature provides an embodiment with the ability to immediately recognize when a guest enters a defined area, which may permit a embodiment to perform the action associated with the detected user device signature, even if the facility manager does not know of the accommodation, does not remember the accommodation, or the like.

As stated above, rather than performing an action responsive to detecting a particular user device signature, an embodiment may perform an action based upon a volume or number of user device signatures. If a threshold value of user device signatures is met or exceeded, an embodiment may take an action to accommodate the volume of people within an area. For example, if an embodiment recognizes that a particular number of device signatures in an area meets or exceeds the predetermined threshold, which may be set by the facility manager or based upon knowledge by the system, an action may automatically occur to accommodate the number of guests within an area, for example, decreasing the temperature in a room, adjusting network bandwidth settings, increasing the water heater temperature, or the like.

The performance of an action by an embodiment may also include requesting user input before performing the action. For example, an embodiment may recognize that a resource characteristic should be adjusted, either through automatic detection or based upon action associations, but may first ask the facility manager to confirm that the action should be taken before performing the action. As an example, if the action includes purchasing an item, for example, a preferred detergent of the guest, a preferred food of the guest, additional resources necessary due to the guest, or the like, an embodiment may first ask the facility manager if the item purchase should be performed. Subsequent to receiving confirmation from the facility manager, an embodiment may perform the action, for example, purchasing the resource using a user's online account. Additionally, since the facility manager has approved the action, an embodiment may store this approval and, thereafter, automatically perform the action without requesting the facility manager approval.

An embodiment may also provide for taking an action ahead of detecting the user device signature in the area, but based upon knowledge that the user device signature will imminently be detected within the area. For example, if an item that needs to be purchased for the guest takes an increased amount of time to arrive an embodiment may purchase the item in advance of the guest arriving the in the area. To determine that the guest will imminently arrive in the area, an embodiment may access a secondary information source (e.g., the Internet, social networking application, user conversations, etc.) to identify that a guest may be arriving and a date of arrival. For example, if the facility manager talks to the guest on the telephone and that conversation indicates that the guest is planning on coming to visit, an embodiment may use this information to identify the guest will arrive in the area. As another example, an embodiment may utilize RSVP information that may establish a list of guests attending a future event. An embodiment may then take an action to ensure that the guest(s) is accommodated when the guest arrives. Alternatively, based upon guest plans, an embodiment may not take an action even though the action is associated with the guest. For example, if an item will not arrive until after the guest leaves, an embodiment may choose not to order the item.

In the case that an action was not associated with a user device signature, after performing an action, either based upon facility manager input indicating the action or based upon automatic determination of an action to take, an embodiment may store the action in association with the user device signature in the data store. In other words, the data store may be updated based upon actions taken by the system in order to maintain a current or updated list of correlations and associations for user device signatures. Additionally, the facility manager may delete associations or provide indications to an embodiment that actions should not occur, thereby causing the system to delete the association.

The various embodiments described herein thus represent a technical improvement to conventional guest preparation techniques. Rather than relying on a home owner, or other facility manager, to manually prepare for the guests, the described system and methods can detect user device signatures and take an action in response to that user device signature. In other words, the described system and method uses a learning technique to identify actions that should be taken in response to detection of user device signatures. For example, the detecting device may determine that last time a person associated with the user device signature was present, certain things occurred (e.g., a certain food was purchased, the facility ran out of hot water, a network bandwidth was overused, etc.), and, therefore, actions should be taken to prevent issues. As another example, the detecting device may determine that a predetermined number of detected user device signatures resulted in a particular problem, so the system can take remedial action before the problem occurs upon detecting that number of user device signatures. Thus, the described system and method provide a technique that is more proactive and requires less manual user intervention (e.g., the user manually preparing for the guests) than conventional techniques. Additionally, the described system and method does not rely on a user manually programming user preferences or settings into the system as required in conventional systems.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
detecting, using one or more detecting devices present within an area and at an information handling device, at least one user device signature in the area;
determining, using a processor, an action to be performed based on the at least one user device signature, wherein the determining comprises identifying an effect of the presence of the at least one user device signature and identifying an action corresponding to the effect, wherein the action is responsive to the effect and accommodates a user corresponding to the at least one user device signature; and
performing, based on the determining, the action.

2. The method of claim 1, wherein the determining the action comprises accessing a data store comprising a list of correlations between user device signatures and actions.

3. The method of claim 1, wherein the action is based upon a number of detected user device signatures.

4. The method of claim 1, wherein the determining comprises identifying an action previously taken in response to a previous detection of the at least one user device signature.

5. The method of claim 1, wherein the performing the action comprises performing the action subsequent to receiving user confirmation to perform the action.

6. The method of claim 5, wherein upon subsequent detection of the at least one user device signature, the confirmed action is automatically performed.

7. The method of claim 1, further comprising identifying a user associated with the at least one user device signature; and
wherein the performing an action is based upon the identified user.

8. The method of claim 1, further comprising associating the performed action with the at least one user device signature and saving, in a data store, the at least one user device signature with the associated performed action.

9. (canceled)

10. The method of claim 1, wherein the information handling device comprises a device within a group of interconnected devices.

11. An information handling device, comprising:
a processor;
a memory device that stores instructions executable by the processor to:
detect, using one or more detecting device present within an area and at an information handling device, at least one user device signature in the area;
determine, using a processor, an action to be performed based on the at least one user device signature, wherein to determine comprises to identify an effect of the presence of the at least one user device signature and identifying an action corresponding to the effect, wherein the action is responsive to the effect and accommodates a user corresponding to the at least one user device signature; and
perform, based on the determining, the action.

12. The information handling device of claim 11, wherein the instructions to determine the action comprise instructions to access a data store comprising a list of correlations between user device signatures and actions.

13. The information handling device of claim 11, wherein the action is based upon a number of detected user device signatures.

14. The information handling device of claim 11, wherein the instructions to determine comprise instructions to identify an action previously taken in response to a previous detection of the at least one user device signature.

15. The information handling device of claim 11, wherein the instructions to perform the action comprise instructions to perform the action subsequent to receiving user confirmation to perform the action.

16. The information handling device of claim 15, wherein upon subsequent detection of the at least one user device signature, the confirmed action is automatically performed.

17. The information handling device of claim 11, further comprising instructions to identify a user associated with the at least one user device signature; and
wherein the instructions to perform an action is based upon the identified user.

18. The information handling device of claim 11, further comprising instructions to associate the performed action with the at least one user device signature and instructions to save, in a data store, the at least one user device signature with the associated performed action.

19. (canceled)

20. A product, comprising:
a storage device that stores code, the code being executable by a processor and comprising:
code that detects, using one or more detecting devices present within an area at an information handling device, at least one user device signature in the area;
code that determines, using a processor, an action to be performed based on the at least one user device signature, wherein the code that determines comprises code that identifies an effect of the presence of the at least one user device signature and identifying an action corresponding to the effect, wherein the action is responsive to the effect and accommodates a user corresponding to the at least one user device signature; and
code that performs, based on the determining, the action.
